(19) United States
(12) Patent Application Publication
(10) Pub. No.: US 2008/0295739 A1
(43) Pub. Date: Dec. 4, 2008

(54) Process for Preparing Alpha Quinacridone Pigments

(75) Inventors: Edward H. Sung, Cincinnati, OH (US); Humberto Arnoldo Velasquez, Cincinnati, OH (US); George H. Robertson, Loveland, OH (US)

Correspondence Address: THERESA O'ROURKE NUGENT;RADEMAKER, NUGENT & AFFLECK, 91 Forest Boulevard, Suite 100, Ardsley, NY, 10502, US

(73) Assignee: SUN CHEMICAL CORPORATION, PARSIPPANY, NJ (US)

(21) Appl. No.: 11/755,381

(22) Filed: May 30, 2007

Related U.S. Application Data
(60) Provisional application No. 60/809,237.

(51) Int. Cl. C09B 48/00

(52) U.S. Cl. 106/497

(57) ABSTRACT

A process for preparing alpha phase quinacridone pigment by ring-closing 2,5-dianilino-terephthalic acid in concentrated polyphosphoric acid, treatment with at least one glycol, followed by striking to water and conditioning the resulting washed pigment with alcohol in the presence of alkali. The resulting pigment is considerably opaque and yellow versus gamma quinacridone of large particle size.

### BACKGROUND OF THE INVENTION

1. Field of the Invention

The present invention relates generally to novel alpha quinacridone pigments, to a process for their preparation, and to products containing them.

2. Description of Related Art

Processes for the preparation of alpha quinacridone pigments are known. See, e.g., S. S. Labana and L. L. Labana, “Quinacridones” in Chemical Review, 67: 1-18 (1967), U.S. Pat. Nos. 2,844,484, 3,790,575, and 5,755,874. The alpha quinacridones thus obtained are generally unsuitable for use as pigments due to their poor stability. Further, they undergo a crystal change from alpha to gamma (see, e.g., U.S. Pat. Nos. 3,372,163, and 3,547,925), or from alpha to beta (see, e.g., U.S. Pat. Nos. 5,755,874, 3,657,248, 3,547,926), when contacted with crystallizing solvent or experiencing elevated temperature.

### BRIEF SUMMARY OF THE INVENTION

An object of the present invention is to remedy the disadvantages of the prior art and to provide superior alpha quinacridone pigments exhibiting enhanced heat stability and lightfastness properties.

These and other objects are found in the present invention of a pigmentary alpha phase quinacridone made by: (1) ring-closing 2,5-dianilino-terephthalic acid in concentrated polyphosphoric acid, (2) treating the resulting pigment with at least one glycol, (3) striking this acidic medium to water and (4) conditioning the resulting washed pigment with at least one alcohol in the presence of alkali and then isolating the resulting alpha phase quinacridone pigment.

The present invention relates in a second embodiment to the resulting alpha phase quinacridone pigment. The resulting product is considerably opaque and yellow versus gamma quinacridone of large particle size.

### BRIEF DESCRIPTION OF THE DRAWING

An embodiment of the invention will now be described with reference to the drawing, wherein:

FIG. 1 is a spectrum comparing an alpha quinacridone pigment of the invention to a gamma quinacridone pigment.

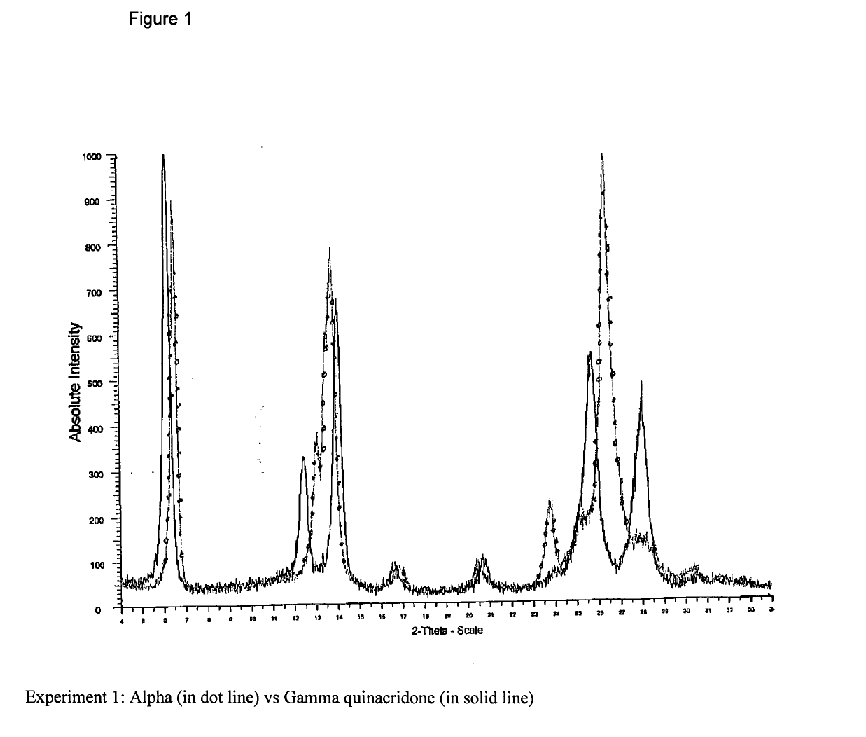

It is understood that the references to the drawing herein are meant to be exemplary of the preferred embodiment(s) described, and that neither the drawing itself, nor any referenced numerals on the drawing are meant to be limiting of the invention in any respect.

### DETAILED DESCRIPTION OF THE INVENTION

The process of the invention includes ring closing 2,5-dianilino-terephthalic acid in high strength polyphosphoric acid. Polyphosphoric acid and 2,5-dianilino-terephthalic acid may be mixed and heated to 100-110° C. in a mixer, or from 100-140° C. in a reactor with a high power agitator. After the 2,5-dianilino-terephthalic acid is fully reacted and cyclized into quinacridone, one or more high boiling glycols may be added. The reaction medium turns soft and begins the swelling process. The length of swelling depends upon the desirable final particle size. In general, longer swelling provides larger particles. The swelled mixture is then added to water to hydrolyze quinacridone-phosphate salt. The resulting product is an alpha-phase quinacridone and can be further pigmented in an alcohol in the presence of alkali.

High strength polyphosphoric acid can be made by adding an amount of phosphorus pentoxide to commercial phosphoric acid. The preferable acid strength for this invention ranges form 116% to 122%. The amount of polyphosphoric acid is approximately 1 fold to 10 fold of 2,5-dianilino-terephthalic acid, preferably 1 fold-to 4-fold. After the addition of 2,5-dianilino-terephthalic acid, the mixture is dissolved in polyphosphoric acid at elevated temperature and cyclized to form quinacridone. The amount of polyphosphoric acid determines the physical nature of the resulting mixture and will be the dependent factor for selecting a suitable reactor or mixer. A higher amount of polyphosphoric acid does not harm the product quality but will increase the cost of production.

Suitable reactors or mixers for this invention include, for example, glass-lined reactors, stainless steel reactors, heavy duty mixers, such as sigma blade attritors, MP mixers, twin screw extruders or other similar apparatuses. For a batch process, suitable equipment is that known as kneader or dough mixers as manufactured by Baker Perkins or J. H. Day. Such machines have the ability to mix the viscous composition of this process. For this batch operation, the pigment intermediate and polyphosphoric acids are loaded into the machine in any order.

High boiling solvents used for this invention include but are not limited to ethylene glycol, propylene glycol, trimethylene glycol, butanediols, diethylene glycol, dipropylene glycol, glycerine, other glycols, and mixtures thereof, all of which would produce alpha crystals of quinacridone. A different solvent can be selected, such as carbitol acetate, which facilitates the growth of particles, but provides gamma phase quinacridone instead. Usually the amount of solvent is about 0.01 to 0.3 times the amount of polyphosphoric acid, preferably between 0.01 to 0.2 times the amount of polyphosphoric acid. The addition of glycols not only results in quinacridone with alpha phase modification, but also improves the flowability of acidic medium which is essential for reducing costs while using a low amount of polyphosphoric acid.

The acidic medium after swelling is added to cold water, possibly through pouring, to hydrolyze the quinacridone-phosphates. The temperature of the acidic medium must be high enough to allow the adequate flow for transferring. It is preferably maintained between 90° C. and 140° C. The water temperature must also be kept low, preferably no higher than 60° C. during the strike or pouring. The resulting product is alpha phase quinacridone and can be further pigmented in low boiling alcohols, such as methanol, ethanol, isopropanol, butanol, isobutanol, other alcohols and combinations thereof in the presence of alkalis. The amount of low boiling alcohols can be four to twenty times the amount of pigment. Any commercially available alkali, such as sodium hydroxide, potassium hydroxide, lithium hydroxide, ammonium hydroxide, or combinations thereof can be used during the pigmentation process.

The color of this alpha quinacridone pigment is very unique and is more yellow and clean than its gamma counterpart. Its excellence in heat stability and lightfastness renders its usage advantageous in any conventional pigment application, for example in paints, inks, coatings, color filters, plastics, fibers, textiles and the like.

The invention will now be described in greater detail with reference to the following non-limiting examples:

### EXAMPLES

### Example 1

80 parts by weight of 2,5-dianilino-terephthalic acid (DATA) are mixed with 200 parts by weight of polyphosphoric acid having an acid strength at 121%. This is done in a sigma blade kneader at room temperature and mixed to wet out dry intermediate, forming a smooth magma. The magma is heated to 100-110° C. and is held with mixing at this temperature for 6 hours. To the hot magma is added 40 parts of dipropylene glycol and kept at a temperature between 95-100° C. for 10 hours. The swelled medium is then hydrolyzed by pouring into a reactor containing 1600 parts of water. The resulting slurry is stirred for three hours and is filtered and washed with water to neutral. This water-washed presscake is then dispersed in 860 parts of methanol and is added to 140 parts of 50% sodium hydroxide solution. This methanol-pigment slurry is heated in a closed vessel for 3 hours at a temperature of 130° C. with stirring. The vessel is then cooled to zero pressure and the pigment is filtered, washed with water to neutral and conductivity of 200 microMhos and dried. The dry product is an alpha phase quinacridone which is coloristically opaque and yellow compound to Sun Chemical's commercially available opaque gamma quinacridone in polyethylene applications. It possesses excellent heat stability in low density polyethylene evaluation.

Delta E change in LDPE

| | Inventive Alpha | Known Gamma |
|---|---|---|
| De* Temp ° F. | Quinacridone | Quinacridone |
| 400-5 | 0.22 | 0.05 |
| 425-5 | 0.44 | 0.05 |
| 450-5 | 0.53 | 0.06 |
| 475-5 | 0.67 | 0.13 |
| 500-5 | 0.78 | 0.15 |
| 525-5 | 1.03 | 0.31 |
| 550-5 | 1.17 | 0.43 |
| 575-5 | 1.22 | 0.52 |

### Comparative Example 1

Example 1 is followed except no dipropylene glycol is added after the ring closure of 2,5-dianilino-terephthalic acid. The hot magma is hydrolyzed by pouring into a reactor containing 1600 parts of water. The resulting slurry is stirred for three hours and is filtered and washed with water to neutral. This water-washed presscake is then dispersed and finished as in example 1. The resulting product is a gamma phase quinacridone which is similar to Sun Chemical's commercially available product in polyethylene application.

### Example 2

80 parts by weight of 2,5-dianilino-terephthalic acid (DATA) are mixed with 200 parts by weight of polyphosphoric acid having an acid strength at 121%. This is done in a sigma blade kneader at room temperature and mixed to wet out dry intermediate, forming a smooth magma. The magma is heated to 100-110° C. and is held with mixing at this temperature for 6 hours. To the hot magma is added 40 parts of carbitol acetate and kept at a temperature between 95-100° C. for 10 hours. The swelled medium is then hydrolyzed by pouring into a reactor containing 1600 parts of water. The resulting slurry is stirred for three hours and is filtered and washed with water to neutral. This water-washed presscake is then dispersed and finished as in example 1. The resulting product is a gamma phase quinacridone which is similar to Sun Chemical's commercially available opaque gamma quinacridone in polyethylene application.

It should be understood that the preceding is merely a detailed description of one preferred embodiment or a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

1. A process for preparing an alpha quinacridone pigment, comprising:
a) ring closure of a 2,5-dianilino-terephthalic acid in concentrated polyphosphoric acid to yield a crude pigment
followed by treating the crude pigment with at least one glycol to yield an acidic medium comprising the crude pigment;
b) adding the acidic medium to water to yield a water washed pigment;
d) conditioning the water washed pigment with at least one alcohol in the presence of alkali; and
e) isolating the resulting alpha quinacridone pigment.

2. The process according to claim 1, wherein the polyphosphoric acid has an acid strength from about 116% to about 122%.

3. The process according to claim 1, wherein the polyphosphoric acid is used in an amount ranging from about 1 to 10 times the amount of 2,5-dianilino-terephthalic acid.

4. The process according to claim 3, wherein the polyphosphoric acid is used in an amount ranging from about 1 to 4 times the amount of 2,5-dianilino-terephthalic acid.

5. The process according to claim 1, wherein the polyphosphoric acid and the 2,5-dianilino-terephthalic acid are mixed.

6. The process according to claim 1, further comprising heating the alpha quinacridone pigment obtained in step d) to a temperature from about 90° to about 140° C.

7. The process according to claim 1, wherein the glycol is selected from the group consisting of ethylene glycol, propylene glycol, butanediols diethylene glycol, dipropylene glycol, glycerine and combinations thereof.

8. The process according to claim 1, wherein the amount of glycol ranges from about 0.01 to about 0.3 times the amount of polyphosphoric acid.

9. The process according to claim 8, wherein the amount of glycol ranges from about 0.01 to about 0.2 times the amount of polyphosphoric acid.

10. The process according to claim 1, wherein the polyphosphoric acid and the 2,5- dianilino-terephthalic acid are mixed with a reactor with a power agitator and wherein the mixer comprises a sigma blade attritor, MP mixer, twin screw extruder, kneader dough mixer or a combination thereof.

11. The process according to claim 1, wherein the alcohol is selected from the group consisting of methanol, ethanol, isopropanol, butanol, isobutanol and combinations thereof.

12. The process according to claim 1, wherein the alkali is selected from the group consisting of sodium hydroxide, potassium hydroxide, lithium hydroxide, ammonium hydroxide, and combinations thereof.

13. An alpha quinacridone pigment obtained by the process according to claim 1.

14. An alpha quinacridone pigment obtained by the process according to claim 1 having improved lightfastness.

15. An alpha quinacridone pigment obtained by the process according to claim 1 having improved heat stability.

16. An ink comprising the alpha quinacridone pigment obtained by the process according to claim 1.

17. A coating composition comprising the alpha quinacridone pigment obtained by the process according to claim 1.

18. A plastic comprising the alpha quinacridone pigment obtained by the process according to claim 1.

19. A paint comprising the alpha quinacridone pigment obtained by the process according to claim 1.

20. A color filter comprising the alpha quinacridone pigment obtained by the process according to claim 1.
